(19) United States
(12) Patent Application Publication
(10) Pub. No.: US 2025/0086538 A1
(43) Pub. Date: Mar. 13, 2025

(54) GENERATING SERVICE JOB ALLOCATIONS BASED ON SERVICE METRIC PREDICTIONS

(71) Applicant: ServiceTitan, Inc., Glendale, CA (US)

(72) Inventors: Juliette Armour-Wilson, Santa Barbara, CA (US); Anya Singer, Glendale, CA (US); Sarah Sheehan, Bastrop, TX (US)

(21) Appl. No.: 18/882,288

(22) Filed: Sep. 11, 2024

Related U.S. Application Data
(60) Provisional application No. 63/581,889, filed on Sep. 11, 2023.

(51) Int. Cl. G06Q 10/0631; G06Q 30/012

(52) U.S. Cl. CPC G06Q 10/063112; G06Q 30/012

(57) ABSTRACT

Aspects of the present disclosure involve systems, methods, computer program products, and the like, for analyzing service job metrics and generating job allocations. Examples may receive resource information associated with a request, and determine a list of resources associated with a tenant based at least in part on the resource information. A first trained machine learning model generates a first value prediction associated with the first service job for each resource in the list of resources. A second trained machine learning model generates a second value prediction associated with a second service job for each resource in the list of resources. For each resource in the list of resources, a comprehensive value prediction is generated based on the first value prediction and the second value prediction. A selected resource of the list of resources undertakes the first service job based on the comprehensive value prediction.

### PRIORITY

This application claims priority to and is a non-provisional of U.S. Provisional Patent Application No. 63/581,889, filed Sep. 11, 2023, which is hereby incorporated by reference in its entirety.

### BACKGROUND

Service technicians (e.g., heating, ventilation, and air conditioning (HVAC) technicians, electricians, plumbers, etc.) may perform service jobs for customers. Computer hardware advancements have been applied to enhance various industry applications. This technology employs different computer capabilities for deploying service technicians to service jobs. The value of the service jobs (e.g., the revenue generated from deploying the service technician to a particular service job) is often determined at the time the service technician arrives at the job location.

Additionally, multiple service technicians may have the skill set and availability to perform a service. But a service job's profitability may differ based on different factors, such as a service technician's distance from the job site, other service requests, and the schedules of available service technicians.

### SUMMARY

Embodiments of the present disclosure generally relate to systems and methods for analyzing service job metrics and generating job allocations. In various examples, embodiments may receive resource information associated with a request, and determine a list of resources associated with a tenant based at least in part on the resource information. The list of resources may include one or more resources available for allocation to perform a first service job associated with the request for a customer. A first trained machine learning model may generate, a first value prediction associated with the first service job for each resource in the list of resources. A second trained machine learning model may generate a second value prediction associated with a second service job for each resource in the list of resources, wherein the second service job is predicted to be performed subsequent to the first service job. Embodiments may generate, for each resource in the list of resources, a comprehensive value prediction based on the first value prediction and the second value prediction. Embodiments may also schedule a selected resource of the list of resources to undertake the first service job based on the comprehensive value prediction.

In some embodiments, a job allocation table may be generated on a graphical user interface. The job allocation table may include the comprehensive value prediction associated with each service technician, and available time windows for each service technician. The graphical user interface may also be configured to receive input to schedule the selected service technician for a time window.

Additional embodiments may include sending an alert to a user device associated with the selected service technician, wherein the alert comprises information associated with the first service job, including job location information and job time information. A first conversion rate may be used to update the first value prediction for a first service technician, and a second conversion rate may update the second value prediction for the first service technician. The first conversion rate may be determined by at least: determining a quantity of service jobs completed by the first service technician with a value above a threshold, determining a total quantity of service jobs completed by the first service technician, and generating, based on the quantity of service jobs and the total quantity of service jobs, a single service job conversation rate associated with the first service technician. The first conversion rate may also be determined by at least: determining a quantity of service jobs that have been completed by the first service technician, that have generated a lead, and that are associated with a value above a threshold, determining a total quantity of service jobs completed by the first service technician, and generating, based on the quantity of service jobs and the total quantity of service jobs completed by the first service technician, a lead conversation rate associated with the first service technician. The second conversion rate may be associated with the at least one service technician performing the second service job.

In some embodiments, the second value prediction for a first service technician may be updated based on a second conversion rate associated with the at least one service technician performing the second service job.

The first machine learning model may be trained to generate the first value prediction associated with the first service job using at least one of: historical data associated with a type of the first service job, historical data associated with the job service provider, and historical data associated with a location of the first service job. The second machine learning model may be trained to generate the second value prediction associated with the second service job using at least one of: historical data associated with a type of the second service job, historical data associated with the at least one service technician, historical data associated with the job service provider, and historical data associated with a location of the first service job. At least one of the first machine learning model and the second machine learning model may be retrained on a regular scheduled basis. At least one machine learning model may be retrained based on the job allocation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The description will be more fully understood with reference to the following figures, which are presented as various embodiments of the disclosure and should not be construed as a complete recitation of the scope of the disclosure, wherein:

FIG. 1 is a block diagram of an example system, in accordance with various embodiments of the subject technology.

FIG. 2 is a flowchart depicting an example method for generating service metric predictions, in accordance with various embodiments of the subject technology.

FIG. 3A is an example user interface, in accordance with various embodiments of the subject technology.

FIG. 3B is another example user interface, in accordance with various embodiments of the subject technology.

FIG. 4 is an example user interface for call tags, in accordance with various embodiments of the subject technology.

FIG. 5A is a flowchart depicting an example method for generating a single value prediction, in accordance with various embodiments of the subject technology.

FIG. 5B is a flowchart depicting an example method for generating a comprehensive value prediction for job allocations, in accordance with various embodiments of the subject technology.

FIG. 6 is a flowchart depicting an example method for job allocation, in accordance with various embodiments of the subject technology.

FIG. 7 is an illustration of an example interface, in accordance with various embodiments of the subject technology.

FIG. 8 is a flowchart for scheduling a service job, in accordance with various embodiments of the subject technology.

FIG. 9 is a diagram illustrating an example of a computing system which may be used in implementing various embodiments of the present disclosure.

An appendix is also attached with which one or more implementations of the subject technology may be implemented.

### DETAILED DESCRIPTION

Aspects of the present disclosure involve systems, methods, computer program products, and the like, for analyzing service metrics associated with a service job, and generating job allocations. Such job allocations may further provide a real-time calendar and schedule, which may be usable by customer service representatives and service technicians. Variations on the systems and methods discussed herein, and in the figures below, may be realized without departing from the spirit and scope of the disclosure.

A tenant can include a job service provider, business, and/or company that performs service jobs (e.g., heating, ventilation, and air conditioning (HVAC) repair and maintenance, electrical or mechanical repair and maintenance, plumbing, etc.) for customers. A tenant may receive requests from its customers. The requests can include requests for the tenant to perform a service job for the customer, such as at a location (e.g., home, business, etc.) associated with the customer. In response to receiving a request from a customer, the tenant may determine one or more job allocations, and dispatch one or more resources, such as service technicians, to the customer location to perform the service job.

However, the tenant may be unaware of the value of the service job before determining whether to dispatch the service technician(s) to perform the service job. Several challenges may arise if the tenant is unaware of the value of the service job before dispatching the service technician(s) to perform the service job. First, if the tenant is unaware of the value of the service job before dispatching the service technician(s) to perform the service job, the tenant may be unable to provide the customer with a quote before the service technician(s) arrives at the location to perform the service job. The service technician(s) may therefore arrive at the location to perform the service job, only to find out that the customer is not willing or able to pay for the service technician(s) to perform the service job. Such an outcome is inefficient and financially detrimental to the tenant.

Second, if the tenant is unaware of the value of the service job before dispatching the service technician(s) to perform the service job, the tenant may be unable to select the most appropriate service technician(s) to dispatch. For example, it may be important for the tenant to dispatch its best service technicians to high value service jobs (e.g., service jobs that generates a significant amount of revenue for the tenant) so that the high value service jobs are completely efficiently and in a satisfactory manner. But if the tenant is unaware that a service job is a high value service job, the tenant may dispatch an inexperienced, inefficient, or lower performing technician to the high value job. If an inexperienced, inefficient, or lower performing technician is dispatched to the high value job, the high value job may be completed incorrectly and/or inefficiently.

Further, even if a tenant is able to predict the value of a service job before dispatching service technician(s) to perform the service job, such as by using historical data associated with that type of service job, the predicted value may be limited to only that single service job. In reality, when a service technician is dispatched to a job location to perform a service job, the service technician often performs additional, related service jobs (e.g., either during the same trip to the job location, or during a future trip to the job location). As such, the actual value that a service job has to the tenant may be far greater than the predicted value of the single service job. Accordingly, improved techniques for service metric (e.g., service job value) prediction are needed.

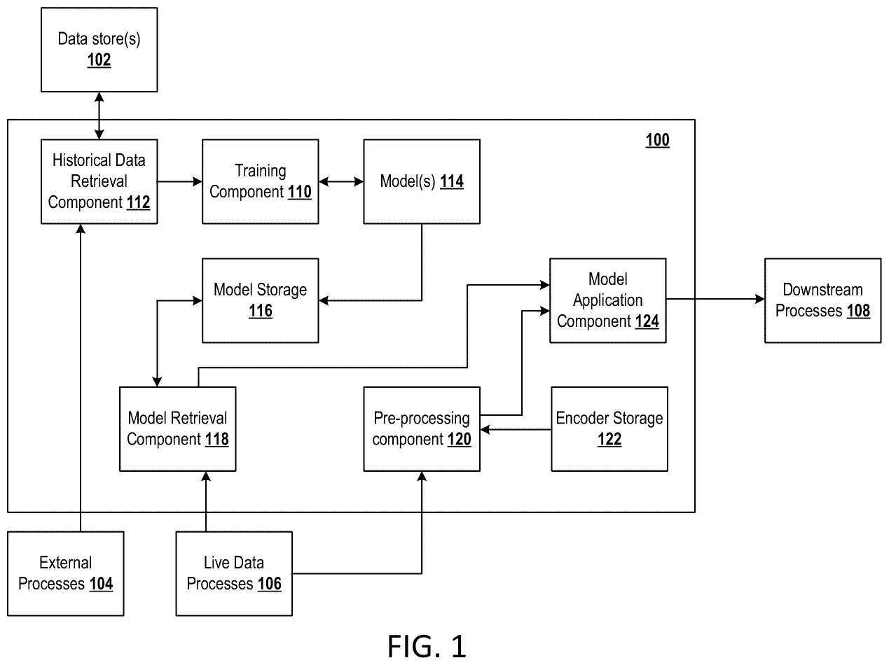

FIG. 1 shows a block diagram of an example system 100. The system 100 may include various functional blocks for performing the functions described herein. For example, the system 100 can interface with data stores 102, external processes 104, live data processes 106, and downstream processes 108. For example, data stores 102 can include the historical record of features associated with a tenant, including features specific to various service job requests received by the tenant. The features may include, for example, service job revenue, profits, service job totals and/or other features over a period of time, which may be used as a target value for training model(s) with which to gauge performance of the trained model as it undergoes training and testing iterations.). External processes 104 can include processes implemented outside the system 100 for obtaining historical data relevant to the job.

A historical data retrieval component 112 can include processes for retrieving historical records pertaining to the job request using data stores 102 and external processes 104. The historical data retrieval component 112 can be located remote to the data stores 102 and/or external processes 104. The data stored in the data stores 102 and/or the data obtained by the external processes 104 can include a large amount of data (e.g., an amount of data that is difficult or impossible to analyze or process manually). The data stored in the data stores 102 and/or the data obtained by the external processes 104 may be obtained from a variety of different sources, such that obtaining all of the data may be difficult or impossible to obtain manually. The historical data retrieved by the historical data retrieval component 112 can be provided to a training component 110.

The training component 110 can include processes for preparing the historical data received from the historical data retrieval component 112 for use as training and test datasets (or subsets). The training datasets can be used for training one or more machine learning models 114 and the testing datasets can be used for testing the machine learning model(s) 114 after they have been trained. For example, the training component 110 can receive historical data associated with a particular company, or tenant from historical data retrieval 112. The historical data can include a historical record of features associated with one or more types of service job that at least one service technician associated with the tenant has previously performed. The training component 110 can divide the received historical data into a training dataset and a testing dataset (e.g., at an approximate respective ratio of 8:2). In embodiments, the training component 110 can generate the training dataset and the testing dataset from the historical data based on determining that an amount of the historical data satisfies a threshold. The threshold may be any amount of historical data, such as a total quantity of completed service jobs (e.g., 50 service jobs, 75 service jobs, 100 service jobs, 125 service jobs), or a total quantity of completed service jobs of a particular type.

The machine learning model(s) 114 may include one or more first machine learning models and one or more second machine learning models. The training component 110 can train the first machine learning model(s) and/or the second machine learning model(s) using the training dataset. The training component 110 can train the first machine learning model(s) to generate value predictions associated with service technician(s) performing a type of service job for customer(s). The training component 110 can train the second machine learning model(s) to generate value predictions associated with service technician(s) performing leads jobs (e.g., at least one different type of service job performed for a customer subsequent to a first service job being performed for that customer).

The trained first machine learning model(s) and the trained second machine learning model(s) can generate value predictions (e.g., predicted values). The models can be trained and tested with an objective of matching the predicted value and a target value (e.g., a job total value indicated by the historical data) during training and testing phases for the model. Training of the first machine learning model(s) and the second machine learning model(s) may be complete when the predicted value and the target value start to converge and/or based on any other suitable criteria. Training the models may include iteratively building decision trees based on the training subset in order to minimize a difference between the predicted values and the target values. Additionally, cross-validation may be used to optimize model parameters. Upon achieving a threshold accuracy during testing the models against the testing subset, the trained models can be stored in a data repository (e.g., database, etc.) to facilitate later retrieval for generating service job value predictions in a live environment.

In embodiments, the trained models may be updated or retrained on a regularly scheduled and/or periodic basis (e.g., nightly, weekly, etc.) to ensure that the values predicted by the models accurately reflect shifts in the market. Live data may be recorded and updated with job total values following completion of the job. The updated recorded data can then be apportioned similarly as described above (e.g., 8:2 of training data to testing data) and provided to the model through a model training process. As a result, each tenant model can keep up with, for example and without imputing limitation, changes in respective campaign identifications, business unit identifications, job type identification, and/or job total values. In effect, the accuracy of the value predictions is less susceptible to deterioration over time after initial model training. Further, the value predictions may adjust to periodic changes, such as seasonal changes and the like.

Once training of the models 114 is complete, the models 114 can be stored in a model storage 116 for later retrieval and use with live data. The model storage 116 can be a local data store, a remote data store, a distributed database or some combination of the above. The model storage 116 can store the models 114 in association with a respective tenant (e.g., the tenant corresponding to the historical data retrieved). The model storage 116 may be accessed by a model retrieval component 118 to retrieve a particular model 114. For example, the particular model 114 may be retrieved for predicting service job value predictions using live data obtained from live data processes 106 and/or for retraining. The retraining of the models 114 can be performed according to a schedule and/or based on triggering events such as generation of a new service job value prediction.

For example, the model retrieval component 118 can retrieve an appropriate model 114 from the model storage 116 based on a request from a live data process 106 for a service job value prediction. The live data processes 106 may include processes for gathering live data, for example from a job request. The live data processes 106 can also include services such as monitoring, management, administration, etc., for managing technician deployments and/or service provisioning by a company (e.g., tenant).

The data preprocessing component 120 can implement preprocessing or data engineering on live data obtained from the live data processes 106. For example, the data preprocessing component 120 can apply encoding (e.g., one-hot encoding), NLP, or other preprocessing on the live data. The encoding can be based on encoders obtained from an encoder storage 122. For example, the data preprocessing component 120 may apply encoding techniques using encoders obtained from the encoder storage 122 to, as an example, convert job unit identifications into an appropriate one-hot vectors for the models 114 to process. In some examples, the data preprocessing component 120 may perform NLP techniques to identify and vectorize natural language text included within the live data.

The model application component 124 can receive the preprocessed data from the data preprocessing component 120 and one or more of the trained models 114. The preprocessed data can be applied to the trained model(s) by the model application component 124 to generate value predictions. The generated value predictions may be an output of the system 100. The value predictions can be provided as an estimate to the customer requesting a job or from whom live data may have been obtained in the live data processes 106. In some examples, the value predictions can be provided to downstream processes 108 to, for example and without imputing limitation, perform scheduling and assignment tasks for technicians, etc. In some examples, where the model application component 124 is unable to produce value predictions using one or more of the models 114 within a certain period of time, such as due to an outage or the like, value predictions may be generated instead by a substitute process, such as an aggregating and averaging process (not depicted) which generates value predictions or other substitute prediction/estimate based on a statistic (e.g., average, mean, median, or other) of job values of a recent window of similar job receipts.

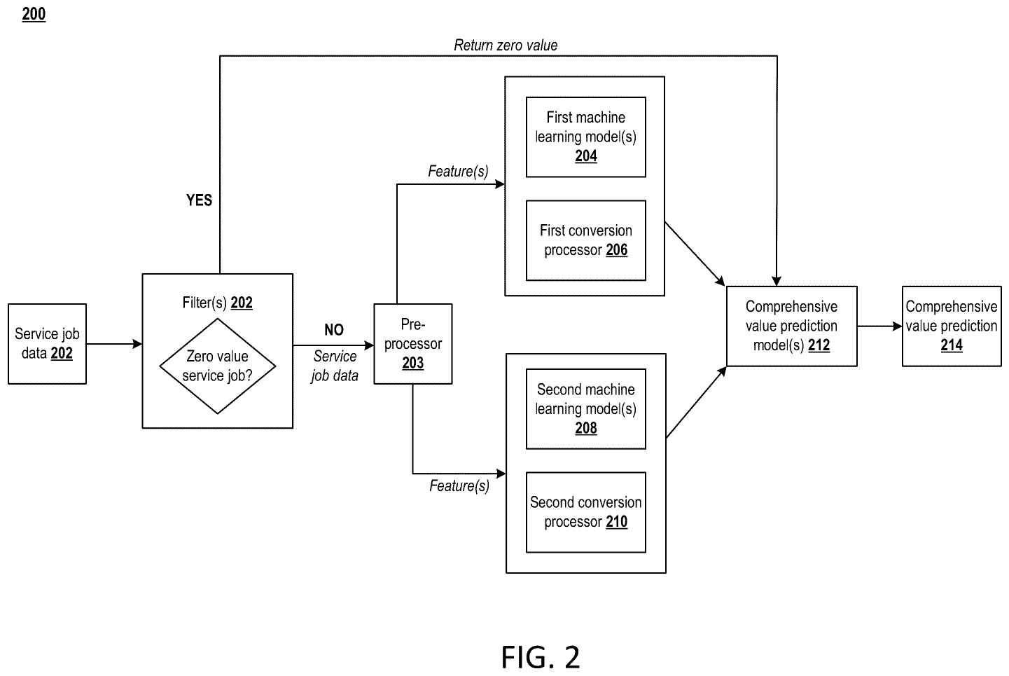

FIG. 2 is an example system 200. The system 200 may be utilized to implement improved techniques for service metric (e.g., service job value) prediction. The system 200 may include one or more filters 202, a pre-processor component 203, at least one first machine learning model 204, a first processor 206, at least one second machine learning model 208, a second processor 210, and/or at least one comprehensive value prediction model 212. The system 200 may enable tenants to gain a better understanding of the actual value that service jobs before dispatching service technicians to complete the service jobs.

The system 200 may receive, as input, data 201. The data 201 may comprise service job data. The service job data can include data indicative of a job request. The job request may have been received by a tenant. For example, the job request can be received by the tenant in the form of a phone call, electronic communication (e.g., instant or text message, electronic mail, via an application programming interface (API)), in person, or any other medium for obtaining information from a customer about a job request. The job request may comprise a request that the tenant perform a service job for the customer. The job request can include service job information such as service job type (e.g., installation, repair, etc.), a requesting business unit, location information, customer history (e.g., credit and/or payment data, etc.), and the like. The data 201 may comprise live (e.g., real-time) data. For example, as the tenant receives a job request from a customer, the system 200 may receive the data 201 as input in real time. The data 201 can be obtained at any point in time, including during the request call itself, through a follow on communication, and/or the like.

In embodiments, the data 201 may be input into and/or pass through the filter(s) 202. The filter(s) 202 is configured to determine whether the service job associated with the job request is a zero value service job (e.g., a service job associated with a monetary value of zero). The service job is a zero value service job if the service job, once completed, will bring in zero revenue for the tenant. To determine whether the service job is a zero value service job, the filter(s) may determine whether the service job is one or more of a recall service job, a warranty service job, and a recurring service included in a subscription. The service job may be a recall service job if the service job needs to be performed in order to remedy an error or oversight previously made by one of the tenant's service technicians. The service job may be a warranty service job if the service job needs to be performed in order to repair an appliance or device that is still under warranty. The service job may be a recurring service included in a subscription if the customer requesting the service job has already purchased a subscription that covers the cost of the service job. The filter(s) 202 may determine whether the service job is a recall service job, a warranty service job, and/or a recurring service included in a subscription based at least one tags included in the data 201.

If the filter(s) 202 determine that the service job is a recall service job, a warranty service job, and/or a recurring service included in a subscription, the filter(s) 202 may determine that the service job is a zero value service job. If the filter(s) 202 determine that the service job is a zero value service job, the filter(s) 202 may send an indication to the comprehensive value prediction model(s) 212. The indication may comprise an indication to return a value of zero for the service job. Conversely, if the filter(s) 202 determine that the service job is not a recall service job, a warranty service job, or a recurring service included in a subscription, the filter(s) 202 may determine that the service job is not a zero value service job. If the filter(s) 202 determine that the service job is not a zero value service job, the service job data 201 may be passed to (e.g., input into) the pre-processor component 203.

The pre-processor component 203 can receive the service job data 201. The pre-processor component 203 can pre-process the service job data 201 to generate a set of features associated with the service job. The set of features may be consumable the first machine learning model(s) 204 and the second machine learning model(s) 208. Pre-processing the data 201 may comprise applying encoding (e.g., one-hot encoding), natural language processing (NLP), applying dimensionality reduction techniques, and/or any other preprocessing on the service job data 201. For example, pre-processor component 203 may apply encoding techniques to, as an example, convert job unit identifications into an appropriate one-hot vectors for the first machine learning model(s) 204 and/or the second machine learning model(s) 208 to process. In some examples, pre-processor component 203 may perform NLP techniques to identify and vectorize natural language text included within the service job data 201. The set of features associated with the service job may be input into the first machine learning model(s) 204, the first processor 206, the second machine learning model(s) 208, and/or the second processor 210.

The first machine learning model(s) 204 can receive the set of features associated with the service job. The first machine learning model(s) 204 is configured (e.g., trained) to generate a first value prediction associated with the service job using the set of features. The first machine learning model(s) 204 may be trained to generate the first value prediction associated with the service job using historical data associated with the tenant. The historical data can include at least one of historical data associated with a type of the service job, historical data associated with the customer, and historical data associated with a location of the service job. The first value prediction associated with the service job can indicate an expected current value associated with performance of the service job. The expected current value associated with performance of the service job may be the revenue associated with performance of the service job that the tenant can expect to collect same day (e.g., the day that the service job is performed).

The first machine learning model(s) 204 may comprise one or more regression models, large language models (LLMs), deep learning models, such as convolutional neural networks (CNNs), recurrent neural networks (RNNs), long short term memory networks (LSTMs), generative adversarial networks (GANs), multilayer perceptrons (MPLs), etc. Where regression algorithms are used, they may include including but are not limited to: Stochastic Gradient Descent Regressors, and/or a Passive Aggressive Regressor, etc.

The first processor 206 can receive the set of features associated with the service job. The first processor 206 can be configured to determine a first conversion rate. The first conversion rate is associated with a particular service technician performing the service job (e.g., the first conversion rate is technician specific). The first processor 206 can determine a different first conversion rate for each of a plurality of service technicians. The first conversion rate for a particular service technician may indicate a likelihood (e.g., probability) that that particular service technician converts the service job request to a sale and/or the likelihood (e.g., probability) that that particular service technician collects a threshold amount of revenue for completing the service job. The first conversion rate can be any value between 0%-100%.

To determine the first conversion rate, the first processor 206 can determine a quantity of service jobs completed by the service technician with a value (e.g., revenue) above a threshold (e.g., $30, $50, $100, $250, etc.). The first processor 206 can determine a total quantity of service jobs completed by the service technician. The total quantity of service jobs may indicate a total number of jobs that the service technician has performed (e.g., for the tenant) and/or a total number of jobs that the service technician has performed (e.g., for the tenant) within a particular time frame. The total quantity of service jobs can exclude service jobs that were performed in relation to a recall or a warranty. The first conversion rate for the service technician may be determined based on the quantity of service jobs completed by the service technician with a value (e.g., revenue) above a threshold and the total quantity of service jobs. For example, the first conversion rate for the service technician may be determined by dividing the quantity of service jobs completed by the service technician with a value (e.g., revenue) above a threshold by the total quantity of service jobs. In embodiments, the first processor 206 comprises a binary classifier. The binary classifier may generate a value of 0 (e.g., 0%) or 100 (e.g., 100%) as the value of the first conversion rate.

Additionally, or alternatively, the first processor 206 can be configured to determine a first average ticket value. The first average ticket value is associated with a particular service technician performing the service job (e.g., the first average ticket value is technician specific). The first processor 206 can determine a different first average ticket value for each of the plurality of service technicians. The first average ticket value for a particular service technician may indicate an average revenue that that particular service technician has collected for completing service jobs in the past.

To determine the first average ticket value, the first processor 206 can determine a quantity of service jobs that have been completed by the service technician with a value (e.g., revenue) above a threshold (e.g., $30, $50, $100, $250, etc.). The total quantity of service jobs may indicate a total number of service jobs that the service technician has performed (e.g., for the tenant) and/or a total number of service jobs that the service technician has performed (e.g., for the tenant) within a particular time frame. The total quantity of service jobs can exclude service jobs that were performed in relation to a recall or a warranty. The first processor 206 can determine a total revenue associated with the service jobs performed by the service technician. The first average ticket value for the service technician may be determined based on the total revenue and the total quantity of service jobs that the service technician has performed. For example, the first average ticket value for the service technician may be determined by dividing the total revenue by the total quantity of service jobs performed by the technician.

The second machine learning model(s) 208 can receive the set of features associated with the service job. The second machine learning model(s) 208 is configured (e.g., trained) to generate a second value prediction associated with at least one different service job using the set of features. The at least one different service job may be predicted to be performed for the customer subsequent to the service job being performed for the customer. For example, the at least one different service job may comprise one or more different jobs that are necessary and/or recommended to be performed after the original service job is performed. The second machine learning model(s) 208 may be trained to generate the second value prediction associated with the different service job(s) using historical data associated with the tenant. The historical data can include historical data associated with a type of the at least one different service job, historical data associated with service technician(s), historical data associated with the customer, and/or historical data associated with a location of the service job. The second value prediction associated with the at least one different service job can indicate an expected future value associated with performance of the service job. The expected future value associated with the at least one service technician performing the service job may be the revenue associated with performance of the different service job(s) that the tenant can expect to collect after the service job is performed.

The second machine learning model(s) 208 may comprise one or more regression models, large language models (LLMs), deep learning models, such as convolutional neural networks (CNNs), recurrent neural networks (RNNs), long short term memory networks (LSTMs), generative adversarial networks (GANs), multilayer perceptrons (MPLs), etc. Where regression algorithms are used, they may include including but are not limited to: Stochastic Gradient Descent Regressors, and/or a Passive Aggressive Regressor, etc.

The second processor 210 can receive the set of features associated with the service job. The second processor 210 is configured to determine a second conversion rate. The second conversion rate is associated with a particular service technician performing the different service job(s) (e.g., the second conversion rate is technician specific). The second processor 210 can determine a different second conversion rate for each of a plurality of service technicians. The second conversion rate for a particular service technician may indicate a likelihood (e.g., probability) that that particular service technician converts a service job request into additional service jobs that are associated with a threshold amount of revenue. The second conversion rate can be any value between 0%-100%.

To determine the second conversion rate, the second processor 210 can determine a quantity of service jobs completed by the service technician that have generated a lead (e.g., led to the performance of additional, different service jobs), where the additional, different service jobs are associated with a value (e.g., revenue) above a threshold (e.g., $30, $50, $100, $250, etc.). The second processor 210 can determine a total quantity of service jobs completed by the service technician. The total quantity of service jobs may indicate a total number of jobs that the service technician has performed (e.g., for the tenant) and/or a total number of jobs that the service technician has performed (e.g., for the tenant) within a particular time frame. The second conversion rate for the service technician may be determined based on the quantity of service jobs completed by the service technician that have generated a lead and the total quantity of service jobs. For example, the second conversion rate for the service technician may be determined by dividing the quantity of service jobs completed by the service technician that have generated a lead by the total quantity of service jobs. In embodiments, the second processor 210 comprises a binary classifier. The binary classifier may generate a value of 0 (e.g., 0%) or 100 (e.g., 100%) as the value of the second conversion rate.

Additionally, or alternatively, the second processor 210 can be configured to determine a second average ticket value. The second average ticket value is associated with a particular service technician performing the different service job(s) (e.g., the second average ticket value is technician specific). The second processor 210 can determine a different second average ticket value for each of the plurality of service technicians. The second average ticket value for a particular service technician may indicate an average revenue that that particular service technician has collected for converting a service job request into additional service jobs. For example, the second average ticket value for a particular service technician may indicate the service technician's average revenue for all sold lead jobs.

To determine the second average ticket value, the second processor 210 can determine a quantity of lead service jobs that have been completed by the service technician with a value (e.g., revenue) above a threshold (e.g., $30, $50, $100, $250, etc.). The total quantity of lead service jobs may indicate a total number of lead jobs that the service technician has performed (e.g., for the tenant) and/or a total number of lead jobs that the service technician has performed (e.g., for the tenant) within a particular time frame. The second processor 210 can determine a total revenue that the particular service technician has collected for performing lead jobs. The second average ticket value for the service technician may be determined based on the total revenue and the total quantity of lead jobs that the service technician has performed. For example, the second average ticket value for the service technician may be determined by dividing the total revenue by the total quantity of lead jobs performed by the service technician.

The comprehensive value prediction model(s) 212 can determine a comprehensive value prediction 214 associated with the service job. The comprehensive value prediction model(s) may receive the first value prediction, the first conversion rate and/or the first average ticket value, the second value prediction, and the second conversion rate and/or the second average ticket value. The comprehensive value prediction model(s) 212 can determine the comprehensive value prediction 214 based on the first value prediction, the first conversion rate and/or the first average ticket value, the second value prediction, and the second conversion rate and/or the second average ticket value. For example, the comprehensive value prediction model(s) 212 can determine the comprehensive value prediction 214 by summing the first value prediction multiplied by the first conversion rate and/or the first average ticket value with the second value prediction multiplied by the second conversion rate and/or the second average ticket value. The comprehensive value prediction 214 associated with the service job indicates both expected current value and expected future value associated with at least one service technician performing the service job.

In embodiments, the comprehensive value prediction model(s) 212 can determine a unique comprehensive value prediction 214 associated with the service job for each of a plurality of service technicians. For example, the comprehensive value prediction model(s) 212 can determine a unique comprehensive value prediction 214 associated with the service job for each of a plurality of service technicians that are available to be dispatched to perform the service job. Because the first and second conversion rates are service technician specific, the comprehensive value predictions 214 may be different for each of the plurality of service technicians.

In embodiments, the comprehensive value prediction(s) 214 are sent to the tenant. For example, the comprehensive value prediction(s) 214 can be sent to one or more computing devices associated with the tenant. The computing device(s) may be located remote to the system 200. The computing device(s) may cause the comprehensive value prediction(s) 214 to be displayed on one or more graphical user interfaces. For example, the comprehensive value prediction(s) 214 may be displayed on an interface of a computing device located at an office or building associated with the tenant. The tenant may view the comprehensive value prediction 214 associated with each of a plurality of available service technicians to determine which service technician to dispatch to the service job and/or to provide the customer with a price estimate before dispatching a service technician to the job site. As another example, the comprehensive value prediction(s) 214 may be displayed on an interface of a mobile computing device (e.g., tablet, mobile phone, etc.) associated with a service technician. The service technician may view the comprehensive value prediction(s) 214 to provide the customer with an accurate value estimate for the service job, such as before the service technician performs the service job.

In embodiments, the system 200 can be utilized to drive efficiency into the lead generation industry. For example, an advertisement service can display an advertisement associated with the tenant, such as via an interface of a user device, such as a computer, laptop, mobile phone, tablet, etc. If a user interacts with the displayed advertisement, such as by clicking on the displayed advertisement, and then books a service job to be performed by the tenant, the system 200 can generate a comprehensive value prediction associated with the booked service job. The comprehensive value prediction can be fed back to the advertisement service. The advertisement service can receive the comprehensive value prediction and utilize the comprehensive value prediction to retrain or update one or more algorithms configured to match advertisements with users. Feeding the comprehensive value prediction back to the advertisement service at the time the service job is booked, instead of waiting days or weeks to feed the actual value of the performed service job back to the advertisement service, significantly improves efficiency in the lead generation industry.

In embodiments, the system 200 can be utilized to identify valuable service job requests for a tenant. For example, a tenant can receive dozens, or even hundreds of service job requests each day. The service job requests can be received in the form of telephone calls, emails, text messages, and/or the like. It can be difficult for the tenant to identify which of these service job requests are the most valuable (e.g., which service job requests the tenant should prioritize). The system 200 can be utilized to determine a comprehensive value prediction associated with each service job request received by the tenant. The comprehensive value prediction associated with each service job request can be displayed and viewed by a user associated with the tenant. The user can view the comprehensive value prediction associated with each service job request to easily determine which of the service job requests are the most valuable (e.g., which service job requests the tenant should prioritize).

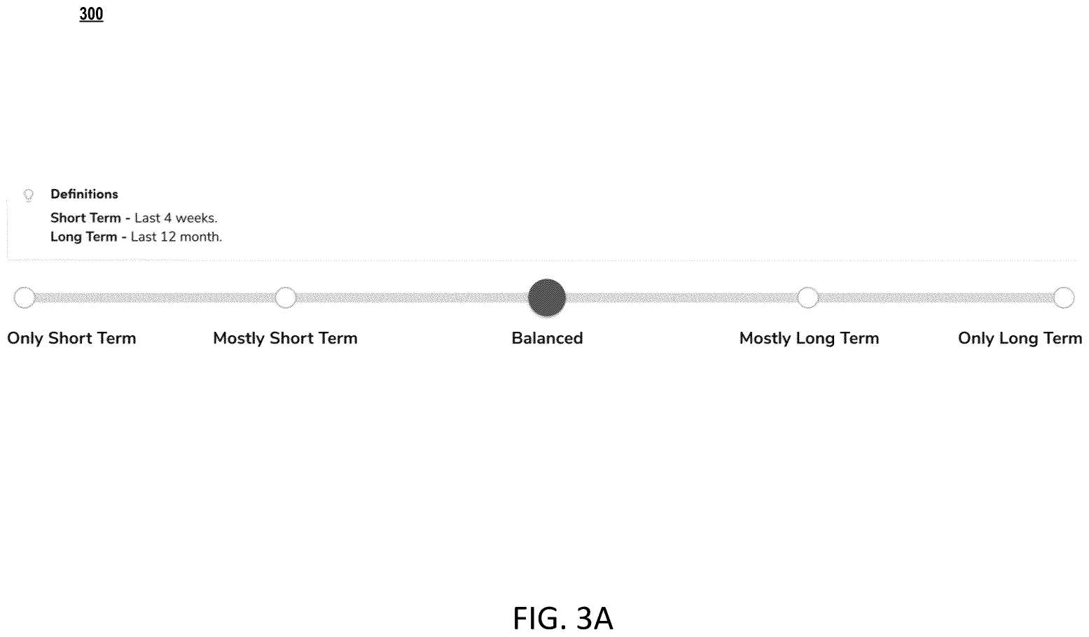

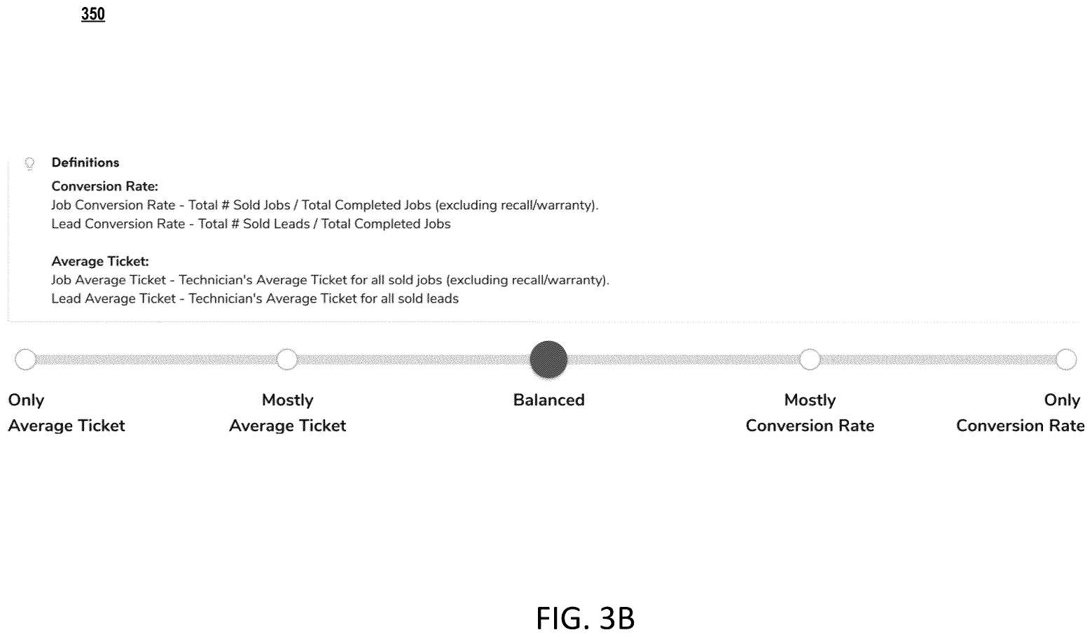

In embodiments, a user, such as a user associated with the tenant, can customize one or more settings associated with the system 200. For example, a user can customize a time frame associated with the first processor 206 and/or the second processor 210. FIG. 3A shows an example user interface 300 for customizing a time frame associated with the first processor 206 and/or the second processor 210. As described above with regard to FIG. 2, the first processor 206 can determine a total quantity of service jobs that the service technician has performed (e.g., for the tenant) within a particular time frame. Likewise, the second processor 210 can determine a total number of lead jobs that the service technician has performed (e.g., for the tenant) within a particular time frame. The time frames utilized by the first processor 206 and/or the second processor 210 can be selected by the user via the user interface 300. For example, the user can select one of the following time frames: only short term, mostly short term, balanced, mostly long term, and only long term.

Additionally, or alternatively, a user can customize a weighting assigned to the conversion rate and average ticket value. For example, a user can customize a weighting assigned to the first conversion rate and the first average ticket value associated with the first processor 206. The user can customize a weighting assigned to the second conversion rate and the second average ticket value associated with the second processor 210.

FIG. 3B shows an example user interface 350 for customizing the weighting assigned to the conversion rate and average ticket value. As described above with regard to FIG. 2, the first processor 206 can determine a first conversion rate and/or a first average ticket value. The comprehensive value prediction model(s) 212 can utilize the first conversion rate and/or the first average ticket value to determine a comprehensive value prediction 214 associated with the service job. Likewise, the second processor 210 can determine a second conversion rate and/or a second average ticket value. The comprehensive value prediction model(s) 212 can utilize the second conversion rate and/or the second average ticket value to determine the comprehensive value prediction 214 associated with the service job.

By customizing the weighting assigned to the conversion rate and average ticket value, the user can control which of the first conversion rate or the first average ticket value (and/or which of the second conversion rate or the second average ticket value) is give more weight when determining the comprehensive value prediction 214 associated with the service job. If the user selects a “balanced” weighting, the conversion rates and the average ticket values can be given an equal weight when determining the comprehensive value prediction 214 associated with the service job. If the user selects a “only average ticket” weighting, the conversion rates can be given no weight when determining the comprehensive value prediction 214 associated with the service job. If the user selects a “mostly average ticket” weighting, the conversion rates can be given some weight, but less weight than the average ticket values, when determining the comprehensive value prediction 214 associated with the service job. Conversely, if the user selects a “only conversion rate” weighting, the average ticket values can be given no weight when determining the comprehensive value prediction 214 associated with the service job. If the user selects a “mostly conversion rate” weighting, the average ticket values can be given some weight, but less weight than the conversion rates, when determining the comprehensive value prediction 214 associated with the service job.

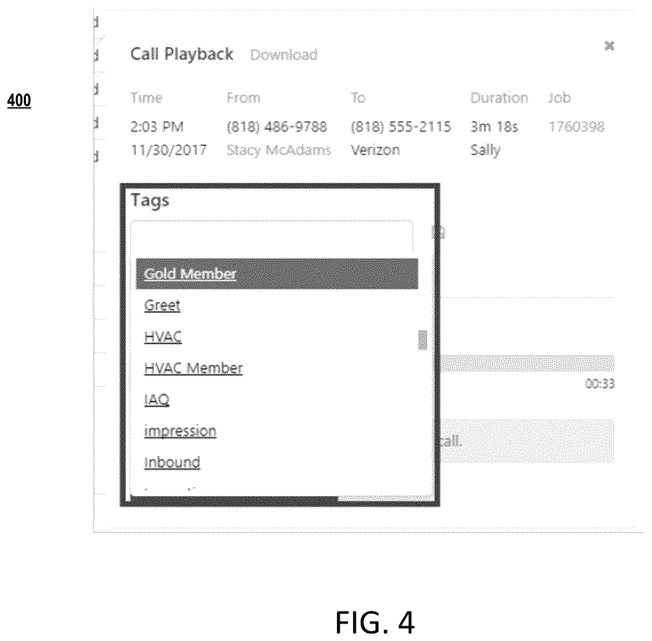

FIG. 4 shows an example user interface 400 for assigning call tags. In examples, a job request can be received via a call. In examples, a call tag can be assigned, automatically or manually, to a call record. In examples where call tag is manually added by a user reviewing the call summary, the user must have the appropriate permissions associated with their account in order to view or edit call forms and tags. A “View Call Forms and Tags” permission gives a user view-only access to review existing call forms and tags. A “Edit Call Forms and Tags” permission gives a user permission to edit existing call forms and tags.

Tags can provide information about the call, including a type of call, a purpose of the call, the caller, and a service job, among others. In some examples, tags can indicate whether the call is an inbound or outbound call, an impression from the call, and the caller type, such as whether the caller is a new member, an existing member, or holds a special status, such as a Gold Member.

In an example, tags can be assigned from a call summary page. A user can navigate to the call summary, and select various options including “Play” call, “Download,” review “Job History,” and review call details, such as call time, date, the name and number of the caller, the name and number of the person or entity the caller contacted, the duration of the job, and a job number associated with the call. Tags assigned to a call can be selected, for example, via a drop down menu, or entered manually. The saved tags will then appear in the call summary.

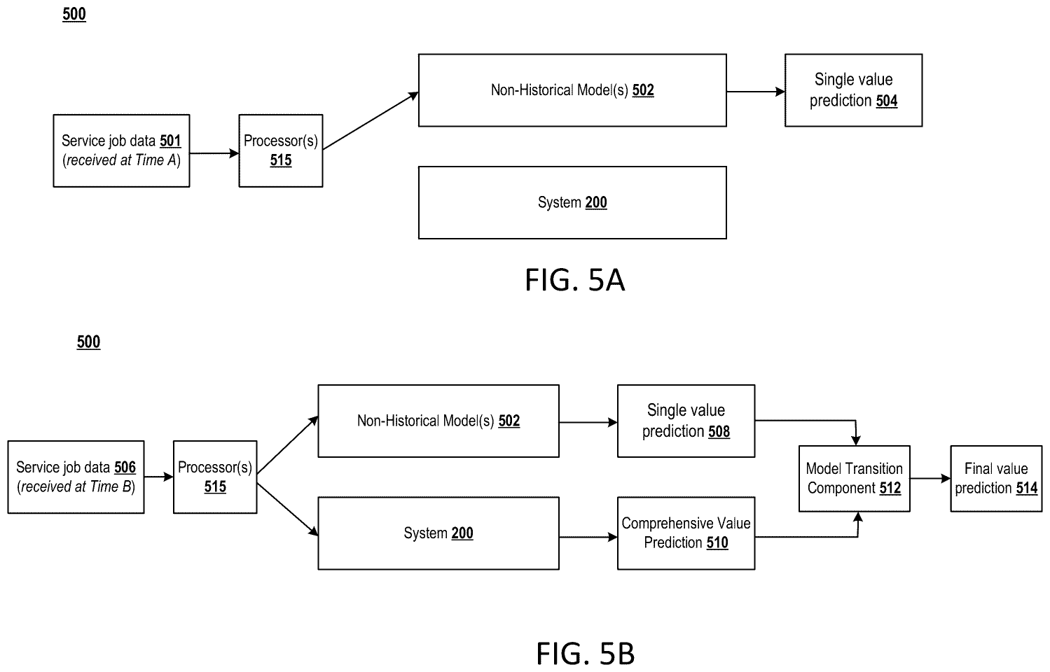

FIG. 5A is an example system 500 (e.g., at a first time). The system 500 may be utilized to implement improved techniques for service metric (e.g., service job value) prediction. The system 500 may include one or more non-historical machine learning model(s) 504 and the system 200. As described above with regard to FIG. 2, the first machine learning model(s) 204 and the second machine learning model(s) 208 of the system 200 are trained using historical data (e.g., historical service job data) associated with the tenant. However, some tenants, such as new tenants and/or tenants that have not utilized the system 200 before, may not be associated with enough historical data to train the first machine learning model(s) 204 and the second machine learning model(s) 208. As such, those tenants may be unable to utilize the system 200 for service value job prediction until they gather enough historical service job data.

As shown in FIG. 5A, service job data 501 may be received. The service job data 501 may be received at a first time (e.g., Time A). The service job data 501 can include data indicative of a first job request. The first job request may have been received by a tenant. For example, the first job request can be received by the tenant in the form of a phone call, electronic communication (e.g., instant or text message, electronic mail, via an application programming interface (API)), in person, or any other medium for obtaining information from a customer about a job request. The first job request may comprise a request that the tenant perform a service job for the customer. The first job request can include service job information such as service job type (e.g., installation, repair, etc.), a requesting business unit, location information, customer history (e.g., credit and/or payment data, etc.), and the like. The service job data 501 may comprise live (e.g., real-time) data. For example, as the tenant receives the first job request from a customer, the system 500 may receive the service job data 501 as input in real time. The service job data 501 can be obtained at any point in time, including during the request call itself, through a follow on communication, and/or the like.

One or more processors 515 may determine whether the tenant is associated with an amount of historical service job data that satisfies (e.g., exceeds) a threshold. The threshold may be any amount of historical data, such as a quantity of completed service jobs (e.g., 50 service jobs, 75 service jobs, 100 service jobs, 125 service jobs). The processor(s) 515 may determine that, at the first time, the tenant is not associated with an amount of historical service job data that satisfies (e.g., exceeds) the threshold. Based on (e.g., in response to) determining that the amount of historical service job data associated with the tenant at the first time does not satisfy the threshold, the processor(s) 515 may send the service job data 501 to the non-historical machine learning model(s) 502. The non-historical machine learning model(s) 502 may generate a single value prediction 504 associated with the service job data 501. The single value prediction 504 can indicate an expected current value, but not future value, associated with the service job. The non-historical machine learning model(s) 502 may be trained to generate the single value prediction 504 using historical data associated with different tenants, such as different tenants that operate in a similar geographic area as the tenant and/or different tenants that perform similar service jobs to the tenant. The single value prediction 504 may be sent to the tenant (e.g., for display via one or more graphical user interfaces).

FIG. 5B is the example system 500 (e.g., at a second time). Service job data 506 may be received. The service job data 506 may be received at a second time (e.g., Time B). The second time may occur after the first time. For example, the second time may occur minutes, hours, days, weeks, months, or years after the first time. The service job data 506 can include data indicative of a second job request. The second job request may have been received by the tenant (e.g., the same tenant that received the service job data 506 at time A). For example, the second job request can be received by the tenant in the form of a phone call, electronic communication (e.g., instant or text message, electronic mail, via an application programming interface (API)), in person, or any other medium for obtaining information from a customer about a job request. The second job request may comprise a request that the tenant perform a service job for the customer. The second job request can include service job information such as service job type (e.g., installation, repair, etc.), a requesting business unit, location information, customer history (e.g., credit and/or payment data, etc.), and the like. The service job data 506 may comprise live (e.g., real-time) data. For example, as the tenant receives the second job request from a customer, the system 500 may receive the service job data 506 as input in real time. The service job data 506 can be obtained at any point in time, including during the request call itself, through a follow on communication, and/or the like.

The processor(s) 515 may determine whether the tenant, at the second time, is associated with an amount of historical service job data that satisfies (e.g., exceeds) the threshold. The processor(s) 515 may determine that, at the second time, the tenant is associated with an amount of historical service job data that satisfies (e.g., exceeds) the threshold. Based on (e.g., in response to) determining that the amount of historical service job data associated with the tenant at the second time does satisfy the threshold, the processor(s) 515 may send the service job data 501 to the non-historical machine learning model(s) 502 and the system 200.

The non-historical machine learning model(s) 502 may generate a single value prediction 508 associated with the service job data 506. The single value prediction 508 can indicate an expected current value, but not future value, associated with the service job. The non-historical machine learning model(s) 502 may be trained to generate the single value prediction 508 using historical data associated with different tenants, such as different tenants that operate in a similar geographic area as the tenant and/or different tenants that perform similar service jobs to the tenant. The system 200 may generate a comprehensive value prediction 510 associated with the second job request. The system 200 may generate the comprehensive value prediction 510 associated with the second job request in the manner described above with regard to FIG. 2. The comprehensive value prediction 510 associated with the second service job request can indicate both an expected current value and an expected future value associated with performance of the service job. The single value prediction 508 and the comprehensive value prediction 510 may be sent to a model transition component 512.

The model transition component 512 may receive the single value prediction 508 and the comprehensive value prediction 510. The model transition component 512 may combine the single value prediction 508 and the comprehensive value prediction 510 to generate a final value prediction 514. For example, the final value prediction 514 may be a weighted average of the single value prediction 508 and the comprehensive value prediction 510. The final value prediction 514 may be sent to the tenant (e.g., for display via one or more graphical user interfaces).

In embodiments, the comprehensive value prediction 510 may be weighted less heavily than the single value prediction 508 if the tenant has only recently acquired enough historical data to satisfy the threshold. The weighting of the comprehensive value prediction 510 may increase, and the weighting of the single value prediction 508 may decrease, over a predetermined transition period (e.g., one week, one month, three months, six months, etc.). Eventually, at the end of the predetermined transition period, the weighting of the comprehensive value prediction 510 may increase to 100%, and the weighting of the single value prediction 508 may decrease to 0%. For example, the single value prediction 508 may no longer be determined and/or utilized at the end of the predetermined transition period. Thus, following the end of the predetermined transition period, the tenant may only utilize the system 200 to generate service job value predictions.

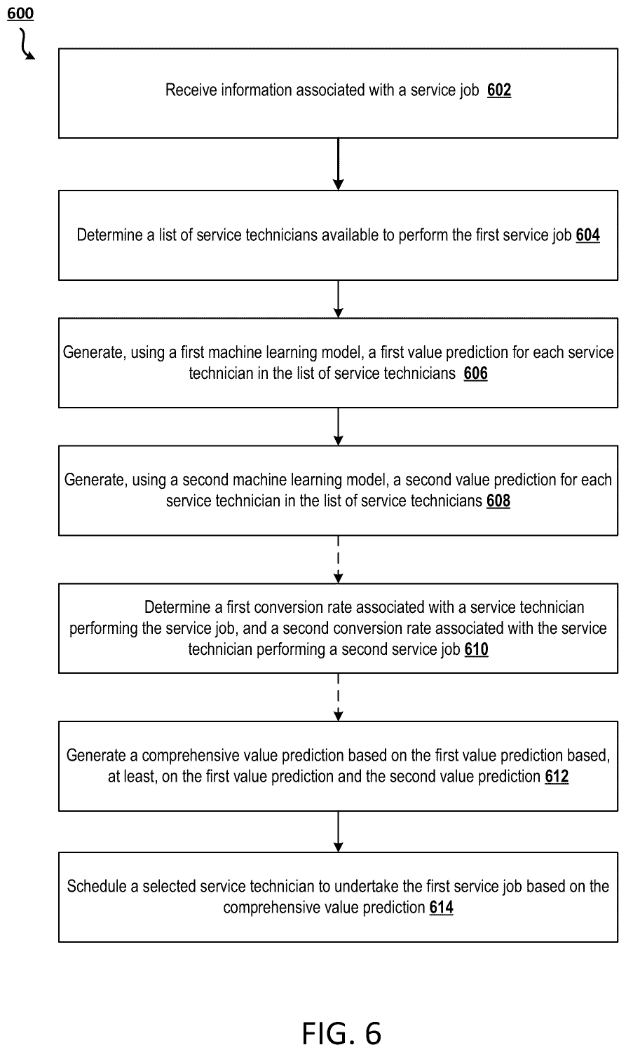

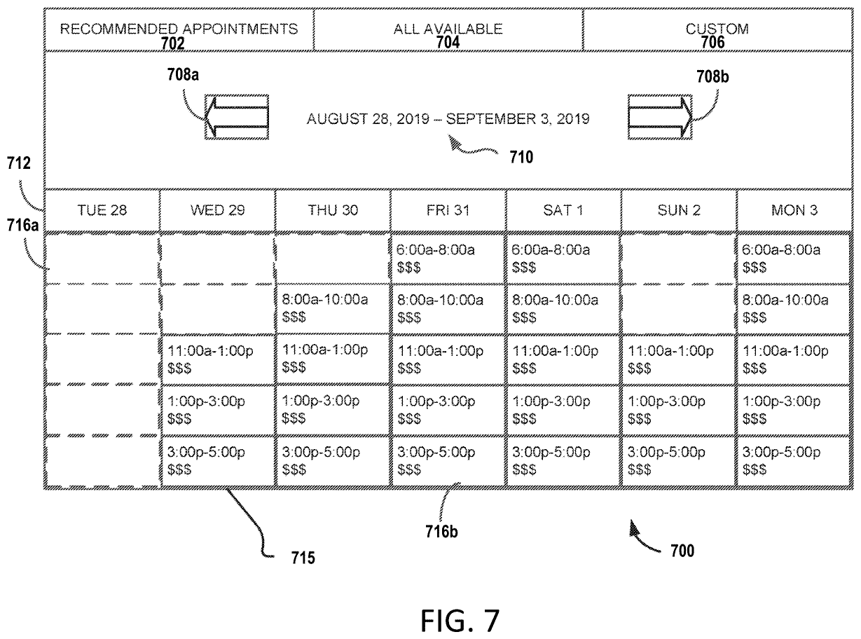

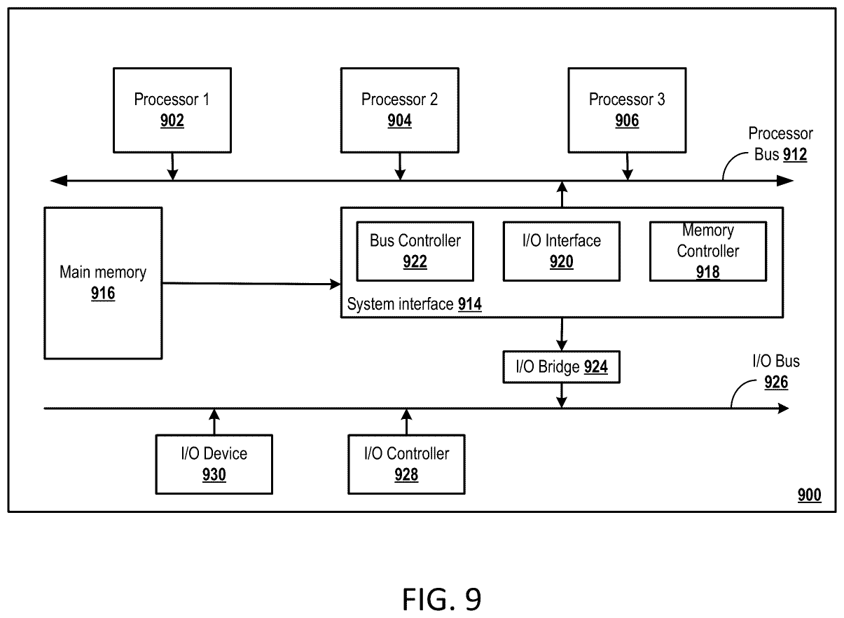

FIG. 6 is a flowchart depicting an example method for job allocation. A system and/or computing environment, such as the system 200 of FIG. 2, the graphical user interface 700 of FIG. 7, and/or the computing environment of FIG. 9, may be configured to perform the method 600.

At block 602, aspects may include receiving information associated with a service job. The data can include data indicative of a job request. The job request may have been received by a tenant. For example, the job request can be received by the tenant in the form of a phone call, electronic communication (e.g., instant or text message, electronic mail, via an application programming interface (API)), in person, or any other medium for obtaining information from a customer about a job request. The job request may comprise a request that the tenant perform a service job for the customer. The job request can include service job information such as service job type (e.g., installation, repair, etc.), a requesting business unit, location information, customer history (e.g., credit and/or payment data, etc.), and the like. The data may comprise live (e.g., real-time) data. For example, as the tenant receives a job request from a customer, the data may be received in real time. The data can be obtained at any point in time, including during the request call itself, through a follow-on communication, and/or the like. The data may be pre-processed to generate a set of features associated with the service job.

At block 604, aspects may determine a list of service technicians available to perform the first service job. The list of service technicians may correspond to service technicians having an availability and a skill set relating to the first service job. In some examples, service jobs may be associated with a set of skills. Service technicians may be assigned one or more skills relating to one or more of a job type, expertise, previous service jobs completed, and experience. The list of service technicians may take additional factors into account, such as a technician availability, technician location, and other service jobs and/or job locations assigned to the service technician.

At block 606, aspects may generate, using a first machine learning model, a first value prediction for each service technician in the list of service technician. The first value prediction may be associated with the service job. The first value prediction may be generated using a first machine learning model. For example, the first value prediction may be generated by inputting the set of features into the first machine learning model. The first machine learning model may be configured to generate the first value prediction associated with the service job using the set of features.

The first machine learning model may be trained to generate the first value prediction associated with the service job using historical data associated with the tenant. The historical data can include at least one of historical data associated with a type of the service job, historical data associated with the customer, and historical data associated with a location of the service job. The first value prediction associated with the service job can indicate an expected current value associated with performance of the service job. The expected current value associated with performance of the service job may be the revenue associated with performance of the service job that the tenant can expect to collect same day (e.g., the day that the service job is performed).

At block 608, aspects may generate, using a second machine learning model, a second value prediction for each service technician in the list of service technicians. The second value prediction may be generated using a second machine learning model. The second value prediction may be associated with a second service job, such as a different service job, a service job commonly associated with the first service job, and the like. The second service job may be predicted to be performed by the at least one service technician subsequent to the at least one service technician performing the service job. For example, the at least one different service job may comprise one or more different jobs that are necessary and/or recommended to be performed after the original service job is performed.

The second machine learning model can receive the set of features associated with the service job. The second machine learning model may generate the second value prediction using the set of features. The second machine learning mode may be trained to generate the second value prediction associated with the different service job(s) using historical data associated with the tenant. The historical data can include historical data associated with a type of the at least one different service job, historical data associated with service technician(s), historical data associated with the customer, and/or historical data associated with a location of the service job. The second value prediction associated with the at least one different service job can indicate an expected future value associated with performance of the service job. The expected future value associated with the at least one service technician performing the service job may be the revenue associated with performance of the different service job(s) that the tenant can expect to collect after the service job is performed.

At block 610, aspects may determine a first conversion rate associated with a service technician performing the service job, and a second conversion rate associated with the service technician performing a second service job. Block 610 may be optional, depending, for example, on whether there is enough information (e.g., historical data, service job information, technician information, etc.) usable to generate the first conversion rate and/or the second conversion rate. In some examples, only one conversion rate (e.g., first conversion rate or the second conversion rate) may be determined. In other examples, no conversion rate is determined. Some examples may omit block 610, in which case the conversion rate determinations are skipped, and the flowchart proceeds as illustrated.

The first conversation rate may be associated with at least one service technician performing the service job (e.g., the first conversion rate is technician specific). A different first conversion rate may be determined for each of the service technicians in the list of service technicians. The first conversion rate for a particular service technician may indicate a likelihood (e.g., a probability) that that particular service technician converts the service job request to a sale and/or the likelihood (e.g., a probability) that that particular service technician collects a threshold amount of revenue for completing the service job. The first conversion rate can be any value between 0%-100%. The first conversion rate for a service technician may be determined based on the quantity of service jobs completed by the service technician with a value (e.g., revenue) above a threshold and the total quantity of service jobs completed by the service technician.

The second conversation rate may be associated with a service technician performing the different service job(s) (e.g., the second conversion rate is technician specific). A different second conversion rate may be determined for each of the plurality of service technicians. The second conversion rate for a particular service technician may indicate a likelihood (e.g., probability) that that particular service technician converts the service job request into additional service jobs that are associated with a threshold amount of revenue. The second conversion rate can be any value between 0%-100%. The second conversion rate for a service technician may be determined based on the quantity of service jobs completed by the service technician that have generated a lead with a value (e.g., revenue) above a threshold and the total quantity of service jobs completed by the service technician.

At block 612, aspects may generate a comprehensive value prediction based, at least, on the first value prediction and the second value prediction. The comprehensive value prediction may further include one or more of the first conversion rate and the second conversion rate. The comprehensive value prediction may therefore be generated based at least on the first value prediction, the second value prediction, and, optionally, the first conversion rate, and the second conversion rate. For example, the comprehensive value prediction may be determined by summing the first value prediction multiplied by the first conversion rate with the second value prediction multiplied by the second conversion rate. The comprehensive value prediction associated with the service job indicates both expected current value and expected future value associated with at least one service technician performing the service job. In embodiments, a unique comprehensive value prediction may be determined for each of a plurality of service technicians (e.g., each of a plurality of service technicians that are available to be dispatched to perform the service job). Because the first and second conversion rates are service technician specific, the comprehensive value predictions may be different for each of the plurality of service technicians.

The comprehensive value prediction(s) may be sent to the tenant. For example, the comprehensive value prediction(s) can be sent to one or more computing devices associated with the tenant. The computing device(s) may cause the comprehensive value prediction(s) to be displayed on one or more graphical user interfaces. For example, the comprehensive value prediction(s) may be displayed on an interface of a computing device located at an office or building associated with the tenant. The tenant may view the comprehensive value prediction associated with each of a plurality of available service technicians to determine which service technician to dispatch to the service job and/or to provide the customer with a price estimate before dispatching a service technician to the job site. As another example, the comprehensive value prediction(s) may be displayed on an interface of a mobile computing device (e.g., tablet, mobile phone, etc.) associated with a service technician. The service technician may view the comprehensive value prediction(s) to provide the customer with an accurate value estimate for the service job, such as before the service technician performs the service job.

At block 614, aspects may schedule a selected service technician to undertake the first service job based on the comprehensive value prediction. In some examples, the selected service technician may be selected based on input provided, for example, at a graphical user interface (e.g., graphical user interface 700 in FIG. 7).

FIG. 7 is an illustration of a graphical user interface (GUI) 700 which a customer service representative, or other user, may use to analyze service metrics and determine job allocations in response to a job request. In some examples, a user may perform method 600 discussed above in reference to FIG. 6, in part or in whole via GUI 700.

GUI 700 includes header tabs 702-706, via which a user (e.g., a customer service representative, tenant, etc.) may change views. In particular header 702 for recommended appoints is depicted in FIG. 7. Nonetheless, header tab 704 may change the view to all available timeslots for booking and header tab 706 may change the view to a customized view.

Calendar section 715 includes a collection of timeslots sequentially organized by day and hour. In particular, calendar section 715 is divided into a week of days demarcated by day columns 712. Here, Tuesday the 28th through Monday the 3rd are depicted. FIG. 7 includes arrows/boxes 708a and 708b that may be used to scroll a calendar from a currently displayed week 710 of Aug. 28, 2019, through Sep. 3, 2019 to either a previous week or a next week. When selection arrow/box 708a is selected, a schedule for a previous week may be displayed in GUI 700 and when selection/arrow box 708b is selected a schedule for a next week may be displayed in GUI 700.

Each respective day is broken into five timeslots correlating to two-hour increments beginning at 6:00 am and concluding at 5:00 pm. For example, a first timeslot in a day column 712 correlates to a 6:00 am-8:00 am timeslot. Likewise, a fifth timeslot in a day column 712 correlates to a 3:00 pm-5:00 pm timeslot.

Further, timeslots may be one of two general types. An unassignable timeslot 716a displays a blank timeslot space to indicate that no technician is available for assignment. In comparison, timeslots 716b include a time window indicator (e.g., 3:00p-5:00p, etc.) and a value indicator in the form of sequential “$” symbols. The value indicator provides a clear indicator of a preference level for assigning a technician to the respective timeslot based on the predicted revenue from the assignment. For example, a timeslot with a “$$” value indicator (not depicted) is predicted to generate less revenue than a timeslot with a “$$$” value indicator. In some examples, a user may interact with timeslots 716b to bring up a list of technicians that may be assigned to the timeslot. The list may be generated according to the systems and methods discussed above.

Once a technician completes a job, scheduling information may be updated automatically. For example, if a technician completes a job before the end of a two-hour period or after the end of a two-hour period, information in the GUI 700 could be updated to identify an actual amount of time that the technician spent performing the job. GUI 700 may also be updated to reflect changes in values, this may occur when a technician identifies and performs additional work for a particular customer. As such, methods consistent with the present disclosure may schedule future events and also track and update work related details as that work is performed. Furthermore, schedules could be re-generated each time a technician provides information to a scheduling computer. For example, when a first technician is expectantly delayed, a second technician may be assigned and dispatched to a job location dynamically on-the-fly.

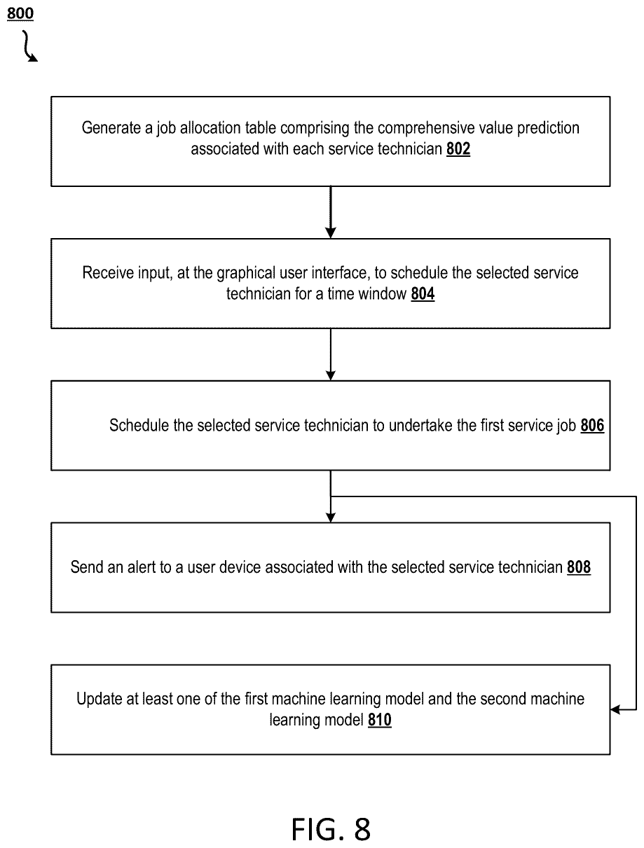

FIG. 8 is a flowchart depicting an example method for job allocation and service job scheduling. A system and/or computing environment, such as the system 200 of FIG. 2, the graphical user interface 700 of FIG. 7, and/or the computing environment of FIG. 9, may be configured to perform the method 800.

At block 802, aspects may generate a job allocation table comprising the comprehensive job value prediction associated with each service technician. As discussed herein, the job allocation table may list available service technicians, time windows associated with each available service technician, and a comprehensive value prediction associated with each service technician and time window. The job allocation table may provide a streamlined, efficient view for a user to identify available technicians, and profitable time slots. Some examples may provide selections for a user to choose a particular service technician and time slot. In some examples, one or more selections may provide additional information regarding at least one of service job information and service technician information.

At block 804, aspects may receive input, e.g., at a graphical user interface, to schedule the selected service technician for a time window. The selection may be performed manually and/or automatically. For example, manual selection may include a user selecting a particular option provided on the job allocation table. An automatic selection may occur based on one or more rules or settings, such as most profitable option. Other factors may be included when scheduling a service technician, such as location, distance to/from a prior or next job, and the like.

At block 806, aspects may schedule the service technician to undertake the first service job. As described herein, this may include updating one or more of the tenant, customer, and service technician systems and/or devices to reflect the allocated job.

At block 806, aspects may send an alert to a user device associated with the selected service technician. The job allocation may, for example, be sent as an electronic message to a computing device associated with the selected technician. In other examples, the alert may be an audible, haptic, or tactile alert.

At block 810, aspects may further update at least one of the first machine learning model and the second machine learning model. The update may be based on information relating to the scheduled service job and assigned service technician. Such job information may be used to retrain one or both models. As discussed herein, one or more models may be trained at a regular, scheduled basis. This may be, for example, every hour, day, or week, and/or after a certain event, such as a job assignment, cancellation, or completion.

FIG. 9 depicts a computing device that may be used in various aspects, such as the devices and/or components depicted in FIGS. 1, 2, 5A and 5B. With regard to the example architecture of FIGS. 1, 2, 5A and 5B, any of the components may each be implemented in an instance of a computing device 900 of FIG. 9. The computer architecture shown in FIG. 9 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 6, FIG. 7, and FIG. 8.

The computer system (system) includes one or more processors (e.g., 902, 904, and 906). The processors 902-906 may include one or more internal levels of cache (not shown) and a bus controller 922 or bus interface unit to direct interaction with a processor bus 912. The processor bus 912, also known as the host bus or the front side bus, may be used to couple the processors 902-906 with a system interface 914. The system interface 914 may be connected to the processor bus 912 to interface other components of the system 900 with the processor bus 912. For example, the system interface 914 may include a memory controller 918 for interfacing a main memory 916 with the processor bus 912. The main memory 916 typically includes one or more memory cards and a control circuit (not shown). System interface 914 may also include an input/output (I/O) interface 920 to interface one or more I/O bridges (e.g., I/O bridge 924) or I/O devices with the processor bus 912. One or more I/O controllers and/or I/O devices may be connected with the I/O bus 926, such as I/O controller 928 and I/O device 930, as illustrated.

I/O device 930 may also include an input device (not shown), such as an alphanumeric input device, including alphanumeric and other keys for communicating information and/or command selections to the processors 902-906. Another type of user input device includes cursor control, such as a mouse, a trackball, or cursor direction keys for communicating direction information and command selections to the processors 902-906 and for controlling cursor movement on the display device.

System 900 may include a dynamic storage device, referred to as main memory 916, or a random-access memory (RAM) or other computer-readable devices coupled to the processor bus 912 for storing information and instructions to be executed by the processors 902-906. Main memory 916 also may be used for storing temporary variables or other intermediate information during execution of instructions by the processors 902-906. System 900 may include a read only memory (ROM) and/or other static storage device coupled to the processor bus 912 for storing static information and instructions for the processors 902-906. The system set forth in FIG. 9 is but one possible example of a computer system that may employ or be configured in accordance with aspects of the present disclosure.

According to one embodiment, the above techniques may be performed by computer system 900 in response to processor 904 executing one or more sequences of one or more instructions contained in main memory 916. These instructions may be read into main memory 916 from another machine-readable medium, such as a storage device. Execution of the sequences of instructions contained in main memory 916 may cause processors 902-906 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 916. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the subject technology may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method, comprising:
receiving resource information associated with a request;
determining a list of resources associated with a tenant based at least in part on the resource information, the list of resources comprising one or more resources available for allocation to perform a first service job associated with the request for a customer;
generating, using a first trained machine learning model, a first value prediction associated with the first service job for each resource in the list of resources;
generating, using a second trained machine learning model, a second value prediction associated with a second service job for each resource in the list of resources, wherein the second service job is predicted to be performed subsequent to the first service job;
generating, for each resource in the list of resources, a comprehensive value prediction based on the first value prediction and the second value prediction; and
scheduling a selected resource of the list of resources to undertake the first service job based on the comprehensive value prediction.

2. The method of claim 1, further comprising:
generating, on a graphical user interface, a job allocation table comprising the comprehensive value prediction associated with each resource, available time windows for each resource, wherein the graphical user interface is configured to receive input to schedule the selected resource for a time window.

3. The method of claim 1, further comprising: sending an alert to a user device associated with the selected resource, wherein the alert comprises information associated with the first service job, including job location information and job time information.

4. The method of claim 1, further comprising at least one of:
updating, for a first resource, the first value prediction with a first conversion rate; and
updating, for the first resource, the second value prediction, based on a second conversion rate associated with the first resource performing the second service job.

5. The method of claim 4, wherein the first conversion rate is determined by at least:
determining a quantity of service jobs completed by the first resource with a value above a threshold;
determining a total quantity of service jobs completed by the first resource; and
generating, based on the quantity of service jobs and the total quantity of service jobs, a single service job conversation rate associated with the first resource.

6. The method of claim 4, wherein the first conversion rate is determined by at least:
determining a quantity of service jobs that have been completed by the first resource, that have generated a lead, and that are associated with a value above a threshold;
determining a total quantity of service jobs completed by the first resource; and
generating, based on the quantity of service jobs and the total quantity of service jobs completed by the first resource, a lead conversation rate associated with the first resource.

7. The method of claim 1, further comprising: updating, for a first resource, the second value prediction, based on a second conversion rate associated with the first resource performing the second service job.

8. The method of claim 1, wherein the first trained machine learning model is trained to generate the first value prediction associated with the first service job using at least one of: historical data associated with a type of the first service job, historical data associated with a job service provider, and historical data associated with a location of the first service job.

9. The method of claim 1, wherein the second trained machine learning model is trained to generate the second value prediction associated with the second service job using at least one of: historical data associated with a type of the second service job, historical data associated with one or more resources of the tenant, historical data associated with a job service provider, and historical data associated with a location of the first service job.

10. The method of claim 1, further comprising retraining at least one of the first trained machine learning model and the second trained machine learning model on a regular scheduled basis.

11. A system, comprising:
a processor; and
a memory comprising instructions stored thereon, which when executed by the processor, cause the system to:
receive resource information associated with a request;
determine a list of resources associated with a tenant based at least in part on the resource information, the list of resources comprising one or more resources available for allocation to perform a first service job associated with the request for a customer;
generate, using a first trained machine learning model, a first value prediction associated with the first service job for each resource in the list of resources;
generate, using a second trained machine learning model, a second value prediction associated with a second service job for each resource in the list of resources, wherein the second service job is predicted to be performed subsequent to the first service job;
generate, for each resource in the list of resources, a comprehensive value prediction based on the first value prediction and the second value prediction; and
schedule a selected resource of the list of resources to undertake the first service job based on the comprehensive value prediction.

12. The system of claim 11, wherein the first trained machine learning model is trained to generate the first value prediction associated with the first service job using historical service job data associated with at least one different customer, and wherein the second trained machine learning model is trained to generate the comprehensive value prediction associated with the second service job using historical service job information associated with a job service provider.

13. The system of claim 12, wherein historical service job data comprises one or more of a service job value total, service job revenue, or profits for the service job performed by the job service provider or one or more other job service providers over a period of time.

14. The system of claim 11, wherein the first trained machine learning model is trained to generate the first value prediction associated with the first service job using at least one of: historical data associated with a type of the first service job, historical data associated with a job service provider, and historical data associated with a location of the first service job, and wherein the second trained machine learning model is trained to generate the second value prediction associated with the second service job using at least one of: historical data associated with a type of the second service job, historical data associated with the at least one resource, historical data associated with a job service provider, and historical data associated with a location of the first service job.

15. The system of claim 11, further comprising retraining at least one of the first trained machine learning model and the second trained machine learning model based on information associated with the first service job.

16. The system of claim 11, further comprising generating, on a graphical user interface, a job allocation table comprising the comprehensive value prediction associated with each resource, available time windows for each resource, wherein the graphical user interface is configured to receive input to schedule the selected resource for a time window.

17. A non-transitory computer-readable storage medium having embodied thereon a program executable by a process for implementing a method for dispatching a resource, the method comprising:
receiving resource information associated with a request;
determining a list of resources associated with a tenant based at least in part on the resource information, the list of resources comprising one or more resources available for allocation to perform a first service job associated with the request for a customer;
generating, using a first trained machine learning model, a first value prediction associated with the first service job for each resource in the list of resources;
generating, using a second trained machine learning model, a second value prediction associated with a second service job for each resource in the list of resources, wherein the second service job is predicted to be performed subsequent to the first service job;
generating, for each resource in the list of resources, a comprehensive value prediction based on the first value prediction and the second value prediction; and
scheduling a selected resource of the list of resources to undertake the first service job based on the comprehensive value prediction.

18. The non-transitory computer-readable storage medium of claim 17, wherein before generating the first value prediction, determining that the first service job is not associated with a value of zero, wherein determining that the first service job is not associated with a value of zero comprises one or more of: determining that the first service job is not a recall service job, determining that the first service job is not a warranty service job, and determining that the first service job is not a recurring service included in a subscription.

19. The non-transitory computer-readable storage medium of claim 17, wherein receiving the information associated with the first service job comprises receiving the data, in real-time and from a job service provider, in response to the job service provider receiving a request to perform the first service job for the customer.

20. The non-transitory computer-readable storage medium of claim 17, further comprising retraining at least one of the first trained machine learning model and the second trained machine learning model on a regular scheduled basis.
